(19) United States
(12) Patent Application Publication
(10) Pub. No.: US 2014/0047564 A1
(43) Pub. Date: Feb. 13, 2014

(54) MANAGING CONTACT RECORDS IN A DEVICE WITH MULTIPLE OPERATION PERIMETERS

(71) Applicants: Robert Emmett McCann, Seattle, WA (US); Diana Jo Schwend, Seattle, WA (US); Hieu Le, Lynnwood, WA (US); Stephen Patrick Newman, Poulsbo, WA (US); Benjamin John Turner, Seattle, WA (US); Atiq Ur Rehman Awan, Ottawa (CA)

(72) Inventors: Robert Emmett McCann, Seattle, WA (US); Diana Jo Schwend, Seattle, WA (US); Hieu Le, Lynnwood, WA (US); Stephen Patrick Newman, Poulsbo, WA (US); Benjamin John Turner, Seattle, WA (US); Atiq Ur Rehman Awan, Ottawa (CA)

(73) Assignee: RESEARCH IN MOTION LIMITED, Waterloo, ON (CA)

(21) Appl. No.: 13/635,110

(22) PCT Filed: Aug. 10, 2012
(86) PCT No.: PCT/US2012/050318

§ 371 Date: Dec. 17, 2012

(51) Int. Cl. G06F 21/62

(52) U.S. Cl. CPC G06F 21/62
USPC 726/30

(57) ABSTRACT

Management of contact records in an electronic device with multiple operation perimeters is provided. When creating a contact record from within one operation perimeter, an option is provided to save the contact record in storage resource accessible from within the current operating perimeter or in a storage resource accessible from within an alternative operation perimeter. If the alternative operation perimeter has a higher security level than the current operation perimeter, a password or other authorization may be required.

### BACKGROUND

Electronic devices, such as tablet computers or smart-phones, may be used for both personal and work activities. It may be useful to protect work data, which may be confidential or proprietary, from being mixed with personal data.

It may be useful for some data, such as contact records, to be accessible from within multiple operation perimeters. In particular, it would be useful to provide a way to effectively and securely manage the creation, retrieval, or modification of contact records in an electronic device with multiple operation perimeters.

### BRIEF DESCRIPTION OF THE DRAWINGS

Example embodiments of the present disclosure will be described below with reference to the included drawings such that like reference numerals refer to like elements and in which:

FIG. 1 is a block diagram of an electronic device in accordance with some example embodiments of the disclosure;

FIG. 2 is a block diagram illustrating operation perimeters of an electronic in accordance with some example embodiments of the disclosure;

FIG. 3 is a flow chart of a method of operation of a shared application in accordance with some example embodiments of the disclosure;

FIG. 4 is a flow chart of a method for creating a contact record on an electronic device in accordance with some example embodiments of the disclosure;

FIG. 5 is an illustrative diagram of an electronic device user interface in accordance with some example embodiments of the disclosure; and

FIG. 6 is a further illustrative diagram of an electronic device user interface in accordance with some example embodiments of the disclosure.

### DETAILED DESCRIPTION

For simplicity and clarity of illustration, reference numerals may be repeated among the figures to indicate corresponding or analogous elements. Numerous details are set forth to provide an understanding of the illustrative example embodiments described herein. The example embodiments may be practiced without these details. In other instances, well-known methods, procedures, and components have not been described in detail to avoid obscuring the disclosed example embodiments. The description is not to be considered as limited to the scope of the example embodiments shown and described herein.

One example way to protect data is for the operating system of an electronic device to implement ‘operation perimeters’, which define environments, spaces or domains within which some data are accessible while others are not. When operating within one operational perimeter, access to data outside of the perimeter is controlled. In particular, leakage of data across an operation perimeter may be prevented.

One example aspect of the disclosure relates to the creation and storage of contact records on an electronic device, where the electronic device provides protected resources only accessible from within a controlled operation perimeter. The electronic device may be, for example, a tablet computer, smart-phone, personal computer, laptop computer, handheld device, PDA, pager or other processor-based device.

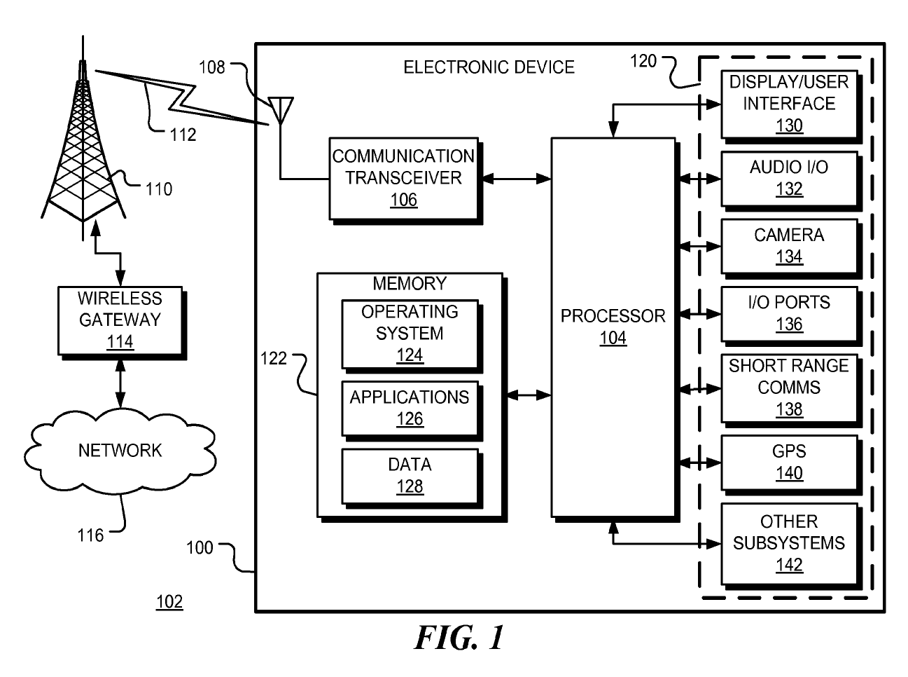

FIG. 1 is a block diagram of an electronic device in accordance with example embodiments of the disclosure. The electronic device may be, for example, a tablet computer, smart-phone, personal computer, laptop computer, handheld device, PDA, pager or other processor-based device. In the example embodiment shown in FIG. 1, the electronic device 100 is part of a communication system 102. The electronic device 100 includes a processor 104 that controls operation of the device. A network interface, including communication transceiver 106 and antenna 108, couples the electronic device to a wireless network 110 via wireless link 112. The wireless network 110 may further couple, via a wireless gateway 114, to a network 116 such as the Internet. In addition to the transceiver 106, the processor has access to a variety of additional resources, including peripheral resources 120 and memory 122.

The processor 104 is controlled by instructions stored in memory 122. These include operating system instructions 124 and application instructions 126. The memory also stores data 128. The memory may be a persistent memory, such as flash memory. Non-persistent memory, such as random access memory (RAM) may also be included.

In addition to the memory 122 and the transceiver 106, the electronic device has additional peripheral resources 120, which may include, for example, a display and user interface 130 (which may be a touch sensitive display, for example), audio I/O 132 (such as loudspeaker, headphone output and microphone), a camera 134 (for example, still image and video capture), general data I/O ports 136, a short range communication sub-system 138, a Global Position System (GPS) sub-system 140 and other sub-systems 142 (which may include an integrated keyboard and/or removable media, for example).

Operation of the processor 104 is controlled by the operating system 124. In accordance with an example aspect of the disclosure, the operating system implements one or more operation perimeters that control access to the transceiver 106, peripheral resources 120, and memory 122. When operating within one perimeter, access to device resources outside of the perimeter is controlled. For example, data security is provided by controlling access to storage resources outside of the perimeter. In particular, leakage of data across a perimeter may be prevented. In addition, some software applications may not be accessible from within all perimeters. An operation perimeter may be implemented using software modules (such as operating system 124), hardware modules, or a combination thereof, that work together to perform operations on the electronic device.

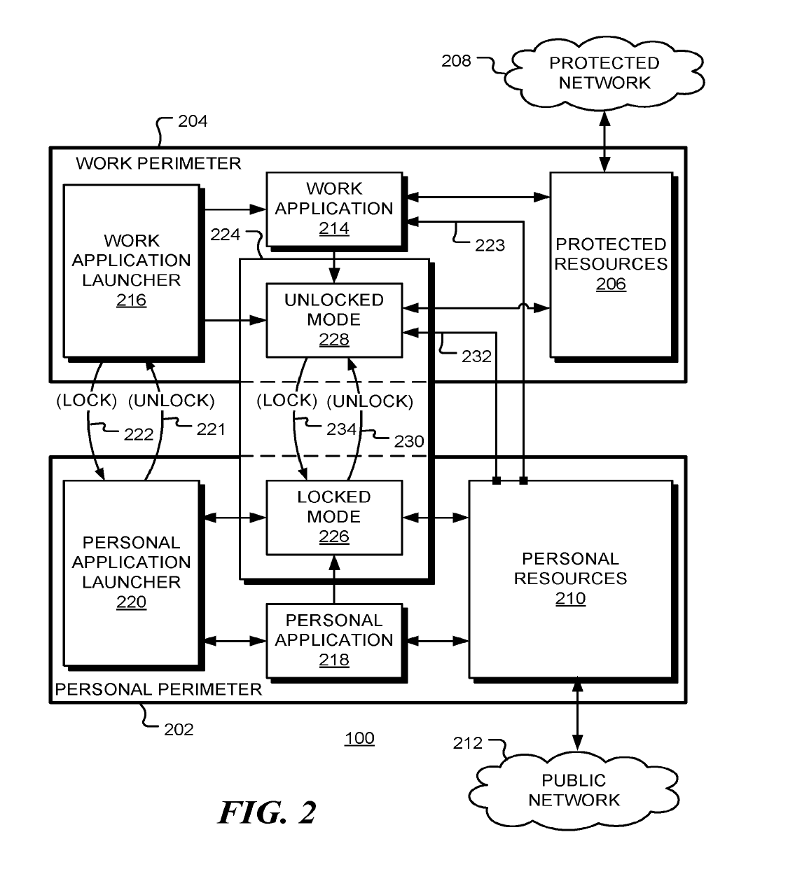

FIG. 2 is a block diagram of an electronic device 100 having a first operation perimeter 202 and a second operation perimeter 204. In this example embodiment, the electronic device 100 may be operated within a work perimeter 204 or within a personal perimeter 202. The following description will refer to this example of work and personal perimeters. However, it is to be understood that more than two perimeters may be implemented and may have different associations. For example, different users of a device may each have their own perimeter or perimeters. Protected resources 206 include, for example, protected memory for storing work data and an interface with a protected network 208 for receiving or transmitting work data, whereas personal resources 210 include, for example, personal memory and an interface to a public network 212. The work perimeter 204 may also include one or more work applications 214, execution of which may be initiated by a work application launcher 216 (such as an icon-based or text-based directory application view). The personal perimeter 202 may also include one or more personal applications 218, execution of which may be initiated by a personal application launcher 220.

Work data, which is only accessible from within the work perimeter 204, may include documents, designs, numerical data, contacts, email messages, calendar entries. To help protect work data, the electronic device 100 creates the work perimeter 204 in its operating system to isolate work data, work applications and other work resources from personal data, personal applications and other personal resources. Work data may be encrypted for additional security.

Access to the interior of the work perimeter 204 is controlled by an authorization process, such as password validation. At initialization of the electronic device, the electronic device is operated within the personal perimeter 202 (or the perimeter having the lowest level of protection) and the work perimeter is ‘locked’, meaning that access to the work perimeter is not permitted without authorization. Personal application launcher 220 may be used to start personal applications 218 that have access to the personal resources 210. If a user wishes to access work applications, the work application launcher 216 may be accessed by ‘unlocking’ the work perimeter, as indicated by arrow 221. Access may be requested, for example, through user interaction with a user interface. Authorization may be achieved by validating a password entered by the user, or by some other authorization (such as biometric data input or gesture recognition etc.). Once inside the work perimeter 204, work applications 214 may be launched having access to the protected resources 206. Optionally, the resources 210 may be accessed, as indicated by arrow 223, but only to retrieve information. Operation may be returned to the personal perimeter by locking the work perimeter as indicated by arrow 222. Locking may be initiated by the user or may occur automatically—such as after a set period of inactivity or a set time since the perimeter was unlocked.

In some example embodiments, it is useful for some applications, resources and/or data to be accessible from within more than one perimeter. An application accessible from within more than one perimeter is termed a shared or hybrid application. An example of a shared application is a contact manager application. Some contact information may need to be protected, while other contact information does not. In FIG. 2, shared application 224 is accessible from within both the work perimeter 204 and the personal perimeter 202. However, when accessed from within the personal perimeter 202, the shared application 224 operates in a locked mode 226. In the locked mode 226, the shared application 224 may only access the personal resources 210. Before the protected resources 206 can be accessed, the operating mode must be changed to an unlocked mode 228, as indicated by arrow 230. As described above, authorization to unlock must be validated. Once in unlocked mode 228, the shared application 224 can access the protected resources 206. Optionally, the resources 210 may be accessed, as indicated by arrow 232, but only to retrieve information. Operation of the shared application 224 may be returned to the locked mode as indicated by arrow 234.

To prevent data leakage from the protected resources to the personal resources, application data is stored in protected resources when the shared application 224 is operated in the unlocked mode 228. Thus, no protected data is available to the application when it returns to the locked mode 226.

An example of a shared application is a contact manager. A contact manager may be launched by user interaction with a user interface, or by another application. For example, an email program may launch a contact manager to enable selection of an email address from a director of email addresses. The contact may be accessible from within more than one perimeter. A contact manager may be used to search a database of contact records, to add new contact records or edit existing contact records.

Contact information, in the form of contact records, may be stored within one more perimeters. Contact information includes, for example, information such as names, aliases, email addresses, work and home addresses, telephone numbers, fax numbers, instant messaging (IM) addresses and web addresses of contacts. Contact information may be stored in a single record or in multiple linked records. Linked records may have one or more common data fields or a common index. In particular, different parts of a contact record may be stored within different perimeters.

In accordance with one example aspect of the disclosure, when creating a contact record from within one operation perimeter, an option is provided by a contact manager (via a user interface) to save the contact record in a storage resource accessible from within the current operating perimeter or in a storage resource accessible from within an alternative operation perimeter. If the alternative operation perimeter has a higher security level than the current operation perimeter, a password or other authorization may be required.

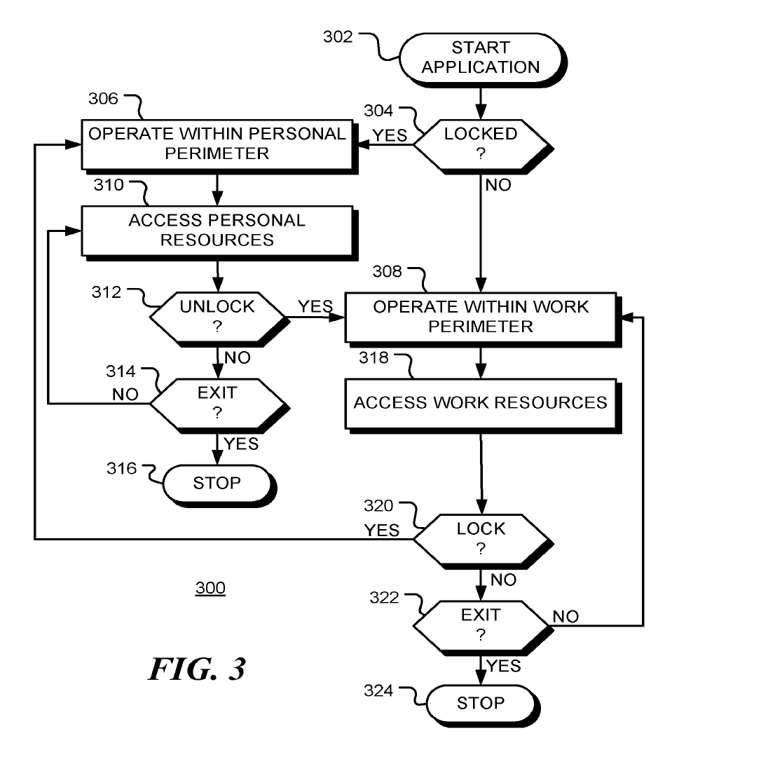

FIG. 3 is a flow chart of a method 300 of operation of a shared application in accordance with some example aspects of the disclosure. In this example embodiment, two perimeters—work and personal—are implemented, but other perimeters could be implemented in other example embodiments. The shared application is launched at start block 302. If the work perimeter is locked, as depicted by the positive branch from decision block 304, the shared application is operated in a locked mode within the personal perimeter at block 306. If the work perimeter is unlocked, as depicted by the negative branch from decision block 304, the shared application is operated in an unlocked mode within the work perimeter at block 308. When operating within the personal perimeter, the shared application may access only personal resources within the personal perimeter, as depicted by block 310. If the application wishes to access a resource within the work perimeter or the user wishes to switch to an unlocked mode of operation, the work perimeter must be unlocked as depicted by the positive branch from decision block 312. For example, if the user wishes to save data to a protected resource, the user may be prompted via a user interface to enter a password or other authorization. The work perimeter is only unlocked if the authorization is validated. Alternatively, a user may indicate via a user interface a desire to operate within the work perimeter. Again, the user is prompted to input an authorization. If the perimeter remains locked, as depicted by the negative branch from decision block 312, flow continues to decision block 314. From decision block 314, flow returns to block 310 unless the application is exited. If the application is exited, as depicted by the positive branch from decision block 314, the method stops at block 316.

When operating within the work perimeter, as depicted by block 308, the shared application may access work resources within the work perimeter, as depicted by block 318. Optionally, the shared application may also retrieve information from resources within the personal perimeter. The shared application may switch to a locked mode of operation, within the personal perimeter, as depicted by the positive branch from decision block 320. This switch may be requested by the user or may be caused automatically when a set criterion is satisfied. For example, the switch may occur once an application has been inactive for a set time. Prior to an automatic switch, the user may be prompted to enter an authorization to remain in the unlocked mode of operation. If the authorization is validated, or if no switch is has been requested, operation continues in the unlocked mode as depicted by the negative branch from decision block 320. If the shared application has been terminated, as depicted by the positive branch from decision block 322, the method terminates at block 324. Otherwise, as depicted by the negative branch from decision block 322, flow continues to block 308 and the shared application continues to operate in the unlocked mode within the work perimeter. In this way, a shared application may be moved between a work mode and a personal mode.

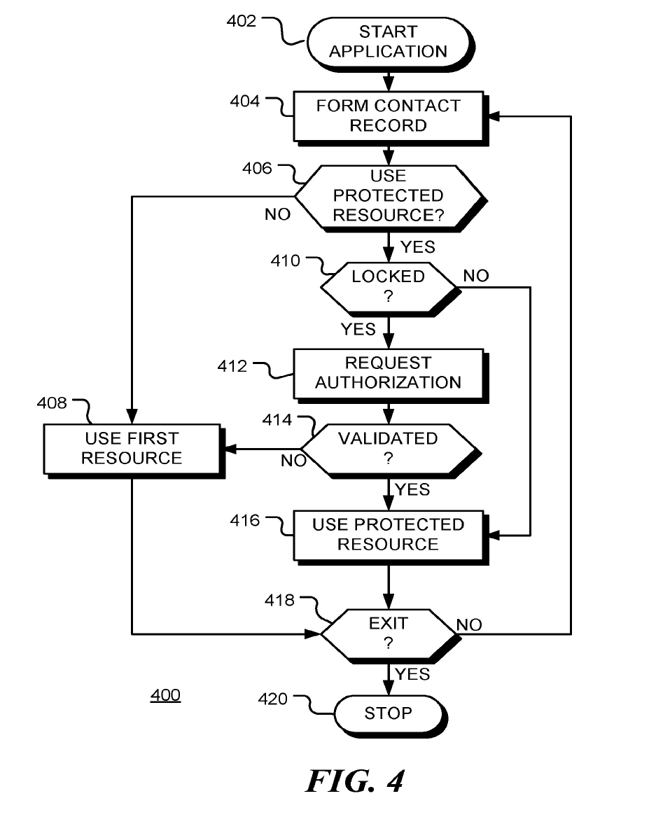

FIG. 4 is a flow chart of a method 400 for creating a contact record on an electronic device in accordance with an example embodiment of the disclosure. The electronic device is operable within first and second operation perimeters, the second perimeter having a protected resource that has restricted access from within the first operation perimeter. At start block 402 execution of an application such as a contact manager is initiated. At block 404 a contact record is formed in response to contact information received. The contact record may be formed, for example, from new contact information, by editing an existing contact record, or a combination thereof. The data may be entered through user interaction with a user interface, such as a touch screen, keyboard or voice interface, or a data interface, such as network connection. If, as depicted by the negative branch from decision block 406, the contact record is not to be passed to the protected resource within the second operation perimeter, the contact record is passed to a resource within the first operation perimeter at block 408. If, as depicted by the positive branch from decision block 406, the contact record is to be passed to a protected resource, flow continues to decision block 410 where it is determined if the second perimeter is locked. If the second perimeter is locked, as depicted by the positive branch from decision block 410, an authorization is requested at block 412. The authorization request may include displaying a message on a display of the electronic device to prompt the user to enter a password. If, as depicted by the positive branch from decision block 414, the authorization is validated, for example by comparing the entered password to a password stored on the electronic device or at a remote location accessible via a network, the contact record is passed to the protected resource at block 416. If the authorization is not validated, as depicted by the negative branch from decision block 414, the contact record may be passed to a first resource at block 408. Alternatively, the user may be prompted to re-enter the password or take some other action. If the application has not been terminated, as depicted by the negative branch from decision block 418, flow continues to block 404 and another contact record may be formed. If the application has been terminated, as depicted by the positive branch from decision block 418, the method ends at block 420.

The protected resource may be, for example, a storage resource such as a local or remote memory, or a protected communication resource, such as a network connection. For example, the contact record may be stored in a storage resource of the second operation perimeter if the authorization is valid for the second operation perimeter.

Once the authorization is validated for the second operation perimeter at block 414, the electronic device may be operated within the second operation perimeter.

If the contact information is received from a user of the electronic device, the user may be prompted to select an operation perimeter of a storage resource in which the contact record is to be stored.

Multiple operation perimeters may be implemented, each having an associated authorization. The operation perimeters may have a flat structure or a hierarchical structure.

If the contact record is to be passed to a protected resource of the second operation perimeter and a set time has elapsed since the contact information was received, the authorization may be requested and validated again before the contact record is passed to the protected resource.

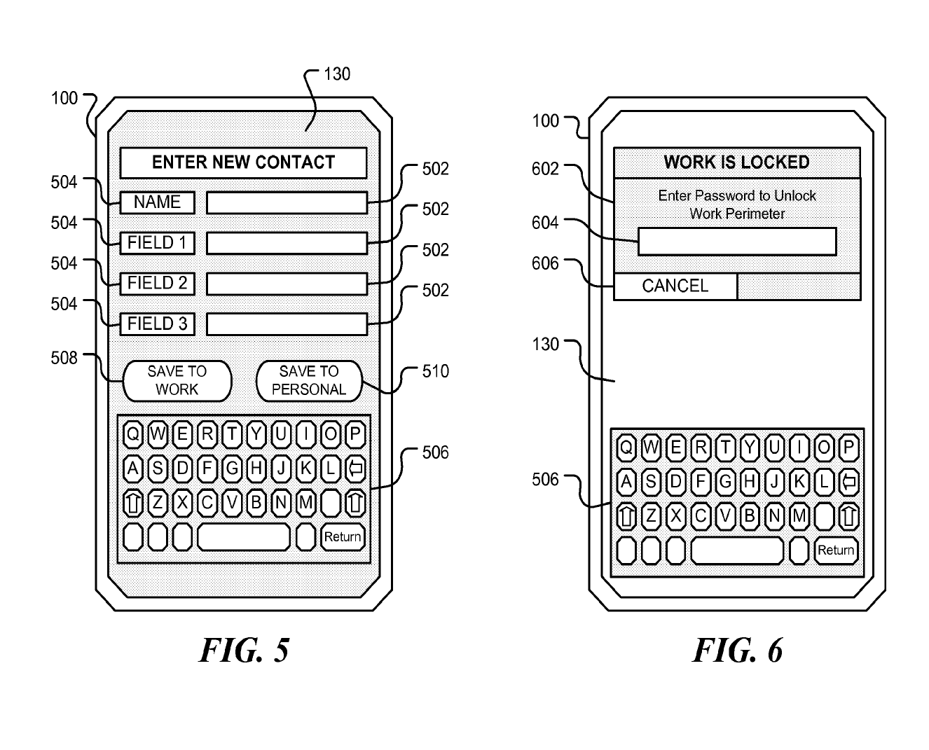

FIG. 5 is an illustrative diagram of an electronic device 100 in accordance with an example embodiment of the disclosure. The electronic device 100 includes a display and user interface 130. When a contact manager application is executed to enter a new contact record, or to edit or append an existing contact record, a data entry form is rendered on the display and user interface 130. The data entry form includes a number of input boxes 502 into which a user can enter contact information. Each box 502 is associated with a data field of a contact record. When editing or appending a previously stored contact record, the input boxes 502 may display the fields of the previously stored contact record. Data fields may include addresses, telephone number, email addresses, IM addresses, web addresses and the like. The data field names are displayed as text 504 on the display 130. Data may be entered by a variety of techniques known to those of ordinary skill in the art. One technique uses a keyboard 506 that may be a physical keyboard or a virtual keyboard rendered on the display and responsive to touch input from a finger or stylus. Handwritten data entered in the boxes 502 using a stylus may be processed by a handwriting recognition module. Voice entries may also be used, in conjunction with a speech recognition module. Entries may be extracted from a received communication and entered automatically. Once data has been entered, the user may select whether the contact record is to be saved in a protected resource within the work perimeter, or a personal resource within the personal perimeter. This may be done by selecting button 508 or button 510, respectively. If the personal perimeter is selected, by selecting button 510, the contact record is saved and operation returns to the contact manager. If the work perimeter is selected, by pressing button 508, and the work perimeter is locked, a new screen is displayed on the display 130, as depicted in FIG. 6. If the personal perimeter is selected, by pressing button 510, the data from the form is stored as a contact record in a personal resource, such as a local persistent memory.

FIG. 6 is an illustrative diagram of an electronic device 100 showing an example embodiment of a request for authorization to unlock a work perimeter. A display box 602 informs the user that work perimeter is currently locked and instructs the user to enter a password into edit box 604 or to cancel the request by selecting button 606. The password may be entered using keyboard 506, for example. Once entered, the password is validated against a stored password and, if validated, the contact record is passed to the protected resource. Other kinds of authorization may be used, including biometric data (such as finger prints, retina scans, voice recognition) or gesture inputs (such as signature recognition).

In one example embodiment, the contact information is received as an electronic business card, such as a ‘vCard’. An electronic business card may be received as an attachment to an email or via another file transfer mechanism. For example, an electronic business card could be downloaded from an Internet web site. When an electronic business card is received, the user is presented with a choice of saving the contact information into the work perimeter or the personal perimeter. If the electronic device is operating within the work perimeter when the electronic business card is received, an authorization may be required before the contact record created from the card's contact information can be saved into the work perimeter.

In a further example embodiment, part of the contact record is stored in a personal resource within the personal perimeter and part of the contact record is stored in a protected resource within the work perimeter. In this example embodiment, access to the protect resource is only granted once a requested authorization has been validated. For example, a colleague's name and home telephone number may be stored in a personal resource, while their work contact information may be stored in the protected resource. A common field or index may be used to link the two parts on of the contact record.

The implementations of the present disclosure described above are intended to be merely examples. It will be appreciated by those of skill in the art that alterations, modifications and variations to the illustrative example embodiments disclosed herein may be made without departing from the scope of the present disclosure. Moreover, selected features from one or more of the above-described example embodiments may be combined to create alternative example embodiments not explicitly shown and described herein.

It will be appreciated that any module or component disclosed herein that executes instructions may include or otherwise have access to non-transient and tangible computer readable media such as storage media, computer storage media, or data storage devices (removable or non-removable) such as, for example, magnetic disks, optical disks, or tape data storage. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the server, any component of or related to the network, backend, etc., or accessible or connectable thereto. Any application or module herein described may be implemented using computer readable/executable instructions that may be stored or otherwise held by such computer readable media.

The implementations of the present disclosure described above are intended to be merely example. It will be appreciated by those of skill in the art that alterations, modifications and variations to the illustrative example embodiments disclosed herein may be made without departing from the scope of the present disclosure. Moreover, selected features from one or more of the above-described example embodiments may be combined to create alternative example embodiments not explicitly shown and described herein.

The present disclosure may be embodied in other specific forms without departing from its spirit or essential characteristics. The described example embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

What is claimed is:

1. A method, implemented on an electronic device, for creating a contact record, the electronic device having a first operation perimeter and a second operation perimeter, comprising:
creating a contact record in response to receiving contact information; and
if the contact record is to be stored in a protected resource of the second operation perimeter having restricted access from within the first operating perimeter and the electronic device is operating within the first operation perimeter:
requesting an authorization;
determining if the authorization is valid; and
storing the contact record in the protected resource of the second operation perimeter if the authorization is valid.

2. The method of claim 1, further comprising:
operating the electronic device within the second operation perimeter if the authorization is valid for the second operation perimeter.

3. The method of claim 1, further comprising:
receiving the contact information from a user interface of the electronic device; and
prompting, through the user interface, selection of an operation perimeter of a storage resource in which the contact record is to be stored.

4. The method of claim 1, where requesting an authorization comprises requesting a password associated with the second operation perimeter.

5. The method of claim 1, further comprising:
if the electronic device is operating within the second operation perimeter and a set time has elapsed since an authorization was validated:
requesting a new authorization; and
operating within the first operation perimeter if the new authorization is invalid for the second operation perimeter.

6. The method of claim 1, further comprising:
if the contact record is to be stored in a protected resource of a second operation perimeter having restricted access from within the first operating perimeter and the electronic device is operating within the second operation perimeter:
storing the contact record in the protected resource of the second operation perimeter.

7. The method of claim 1, where the received contact information comprises new contact information.

8. The method of claim 1, where the received contact information comprises a combination of previously stored contact information and new contact information.

9. The method of claim 1, where the received contact information comprises an electronic business card.

10. A method, implemented on an electronic device, for creating a contact record, the electronic device having a first operation perimeter and a second operation perimeter, comprising:
creating a contact record in response to receiving contact information; and
if a first part of the contact record is to be stored in a first memory of the first operation perimeter and a second part of the contact record is to be stored in a second memory of a second operation perimeter having restricted access from within the first operating perimeter:
storing the first part of the contact record in the first memory of the first operation perimeter;
requesting an authorization; and
storing the second part of the contact record in the second memory of the second operation perimeter if the authorization is valid.

11. The method of claim 10, where storing the first part of the contact record in the first memory of the first operation perimeter comprises:
storing a link to the second part of the contact record in the first memory of the first operation perimeter.

12. The method of claim 10, where the received contact information comprises an electronic business card.

13. An electronic device comprising:
an input operable to receive contact information;
a processor operable, within one of a first operation perimeter and a second operating perimeter, to create a contact record in response to the received contact information;
a first storage resource accessible from within the first operation perimeter; and
a second storage resource accessible from within the second operation perimeter and inaccessible from within the first operation perimeter;
the processor further operable to store at least part of the contact record in the second storage resource if a requested authorization is valid for the second operation perimeter.

14. The electronic device of claim 13, where the processor is further operable to store the at least part of the contact record in the second storage resource if the processor is operating within the second operation perimeter.

15. The electronic device of claim 13, where the requested authorization comprises a password for the second operation perimeter.

16. The electronic device of claim 13, where the second storage resource comprises a protected memory of the electronic device.

17. The electronic device of claim 13, further comprising:
a network interface, accessible from within the second operation perimeter,
where the second storage resource comprises a remote memory accessible through the network interface.

18. The electronic device of claim 13, where the input comprises a network interface and where the received contact information comprises an electronic business card.

19. The electronic device of claim 13, where the input comprises a user interface of the electronic device.

20. The electronic device of claim 13, further comprising:
an input operable to receive a requested authorization selected from a group of authorizations consisting of an audio input, a touch input, a motion input, a retina scanner and a fingerprint scanner,
where the processor is operable to determine a validity of the requested authorization.

21. A non-transitory computer-readable medium having processor-executable instructions that, when executed by a processor, cause the processor to perform operations comprising:
creating a contact record in response to contact information received when operating within a first operation perimeter; and
if at least part of contact record is to be stored in a storage resource of a second operation perimeter having restricted access from within the first operating perimeter:
requesting an authorization;
determining if the authorization is valid for the second operation perimeter; and
storing the at least part contact record in the storage resource of the second operation perimeter if the authorization is valid for the second operation perimeter.
